(19) United States
(12) Patent Application Publication
(10) Pub. No.: US 2005/0048961 A1
(43) Pub. Date: Mar. 3, 2005

(54) System and method for providing communication services to mobile device users

(75) Inventors: Charles S. Ribaudo, Dallas, TX (US); James F. Young, Dallas, TX (US)

Correspondence Address: HAYNES AND BOONE, LLP, 901 MAIN STREET, SUITE 3100, DALLAS, TX, 75202, US

(73) Assignee: Jambo Networks, Inc., Dallas, TX (US)

(21) Appl. No.: 10/928,857

(22) Filed: Aug. 27, 2004

Related U.S. Application Data
(60) Provisional application No. 60/498,084, filed on Aug. 27, 2003.
(60) Provisional application No. 60/547,509, filed on Feb. 25, 2004.

(51) Int. Cl. H04M 3/00

(52) U.S. Cl. 455/419; 455/418

(57) ABSTRACT

The present disclosure relates generally to communication services, and more specifically to a system and method for providing communication services to mobile device users. In one example, a method of providing communication services to a plurality of mobile device users includes: entering a first set of data into a data center by a user; processing the first set of data in the data center to generate a second set of data; downloading the second set of data to a first mobile device to form a third set of data to be stored on the first mobile device; and detecting, by the first mobile device, a second mobile device according to the third set of data, and the second mobile device is located within a range of the first mobile device, and communication between the first mobile device and the data center after downloading the second set of data is not required for detecting the second mobile device.

### CROSS-REFERENCE TO RELATED APPLICATION

This Application claims priority to the U.S. Provisional Application No. 60/498,084 filed on Aug. 27, 2003 entitled “System and Method for Personal Area Matching”, and the U.S. Provisional Application No. 60/547,509 filed on Feb. 25, 2004 entitled “Personal Area Matching”, each of which is hereby incorporated by reference in its entirety.

### BACKGROUND

Network building is an important function in this society. However, it is challenging to identify targeted people from a random selection of the general population. Traditionally, people join organizations and attend events, but such activities are extremely time consuming.

Recently, people began to explore the Internet for “meeting” each other, utilizing formats such as chat rooms and news groups. A chat room enables its users to enter and receive messages in real time, while a news group enables its users to post and reply to messages. However, frequently, users of such a chat room and news group are located in different geographical regions. As a result, it may require elaborate planning for people sharing common interests to locate and meet each other.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates an exemplary method for providing communication services to mobile device users.

FIGS. 2-3 illustrate exemplary systems for implementing the method of FIG. 1.

### DETAILED DESCRIPTION

The present disclosure relates generally to communication services, and more specifically to a system and method for providing communication services to mobile device users.

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Previously available methods for networking possess a number of disadvantages. For example, even though users belonging to an identical news group or the same university association may encounter each other in a public location, they are frequently unaware of such opportunities to meet each other. In another example, at a large conference with thousands of people at the event, it is difficult for an attendee to determine the most relevant people to meet. In addition, even online networking sites that provide opportunities for users to network with one another online, still possess a number of disadvantages, because those users still need to go through the elaborate process of going to those online sites to network with other users and then scheduling a time and place to meet with one another face-to-face.

Therefore, among other things, it is desirable to provide a system and method for users with shared commonality to detect each other in proximity.

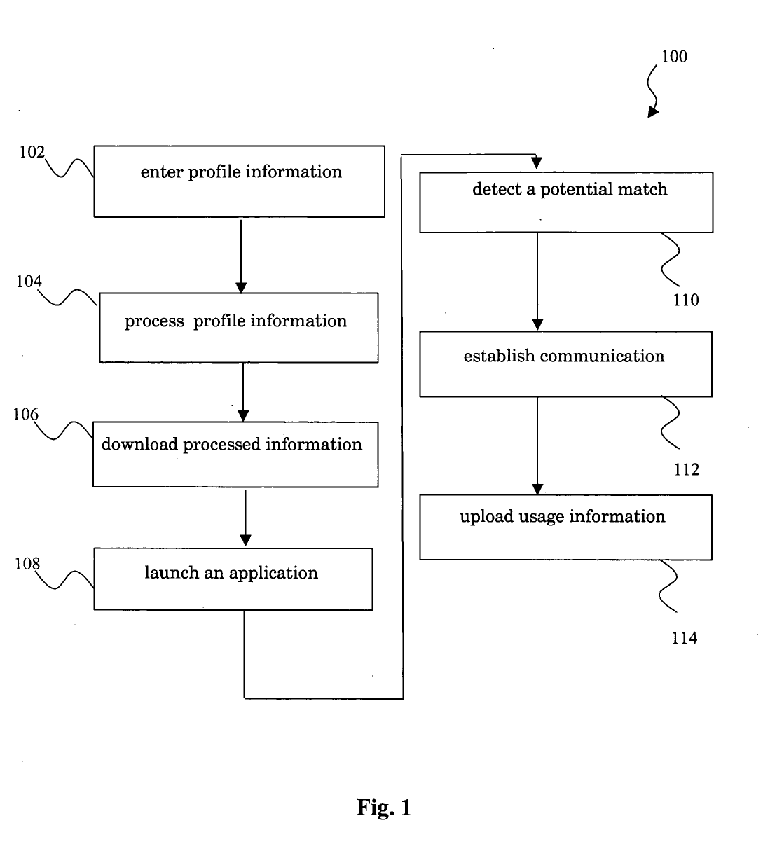

Referring now to FIG. 1, shown therein is an exemplary method 100 for providing communication services to mobile device users. Pursuant to the method 100, potential matches are pre-processed at a centralized location, and downloaded to mobile devices. As a result, when users encounter each other in proximity, they are able to detect each other based on information stored in their mobile devices. Accordingly, they may communicate with each other immediately or at a later time to facilitate potential meetings.

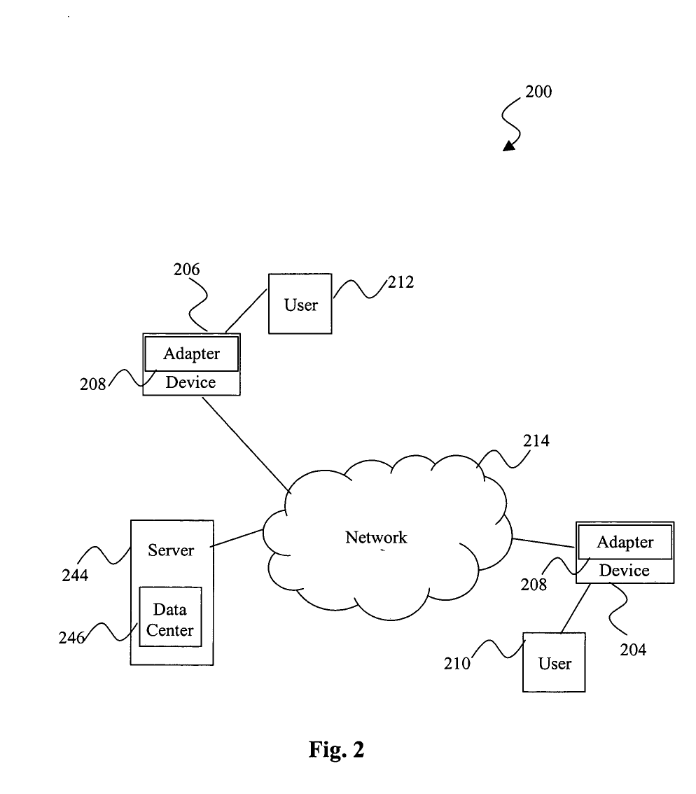

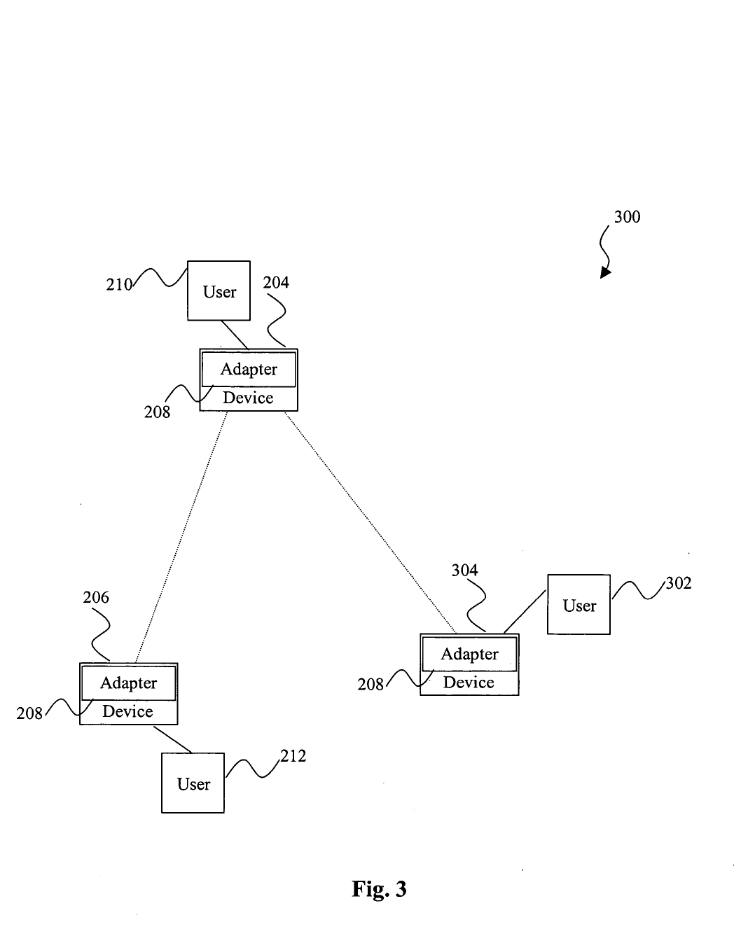

In one embodiment, the system 100 may initiate with step 102, pursuant to which a user enters his profile information into a centralized system. Then, pursuant to step 104, the profile information is processed at the centralized system, and the processed results are distributed to his mobile device pursuant to step 106. According to step 108, the user launches an application on his mobile device, and potential matches are detected pursuant to step 110. Then, pursuant to step 112, communication between matched users is established. Pursuant to step 114, usage information after encounters is uploaded to the data center. The method 100 will be further described in connections with FIGS. 2-3 below.

Referring now to FIG. 2, shown therein is an exemplary system 200 that may be used to implement steps 102 to 106 of the method 100. The system 200 may include one or more devices 204 and 206 that may be connected to a network 214. The network 214 may be a single network or a variety of different networks, such as an intranet and the Internet, and may include both wireline and wireless communication channels.

Each of the devices 204 and 206 may include a computing or communication device such as a WiFi device, palm device, personal computer, laptop, Bluetooth device, personal digital assistant, pager, cellular telephone, game console, camera, or any other suitable device. An adapter 208, which may include one or more application programs, resides on each of the devices 204 and 206. The adapter 208 may include one or more programs based on one or more programming languages, such as C, C++, C#, Java, and/or any other language. From the perspective of the device 204, the adapter 208 may be used to facilitate the communication between the device 204 and the data center 246/device 206.

In one embodiment, the adapter 208 may include a protocol driver (not shown), that provides several functions, including but not limited to the utilization of a broadcast service set identifier (SSID). Assuming a network driver interface specification (NDIS) compliant 802.11 network interface card (NIC) is present, the adapter 208 may take advantage of the 802.11 frame or media access control (MAC) layer for detecting other users in proximity. In the absence of a NDIS compliant card, the adapter 208 may still function on the same logical network (for example, the same Internet protocol (IP) subnet). Additionally, the protocol driver may be designed so as not to require NDIS compliance.

The protocol driver may facilitate multi-hop messaging without requiring proprietary wireless local area network (WLAN) cards or transmission control protocol/internet protocol (TCP/IP) drivers. Using the protocol driver to pass messages between users who are out of range, other users can act as wireless routers to form mesh networks, so that a user is not restricted by the approximately 300-foot range from a single-hop WiFi network.

In this example, each of the devices 204 and 206 may be connected to the network 214 through a wireless or wired link, and may be identified on the network 214 by an address or a combination of addresses, such as a media access control (MAC) address associated with the network interface and an IP address.

The system 200 may include a data center 246, which may reside on a server 244 or any other device that is connected to the network 214. The data center 246 may include one or more programs based on one or more programming languages, such as C, C++, SQL, Java, and/or any other language. The data center 246 is used to process data entered by users 210 and 212 as described below during step 104.

Step 102 of the method 100 will now be further described. In one embodiment, through the device 204, the user 210 (or the user 212) may enter any desired profile information, such as affiliations, contacts, background, or any other suitable information, into the data center 246. It is contemplated that the user 210 may alternatively utilize the device 206, or any other device that can access the data center 246 (including but not limited to a personal computer, laptop, palmtop, cell phone, game console, and camera) to enter such profile information. Also, a user ID may be adopted for the user 210 for authentication purposes.

A third party may create and enter profile information for a user. In addition, usage information of the user's usage of the service can be automatically entered into the profile for the user. Usage information such as number of matches encountered, types of matches encountered, number of users messaged, length of messaging, success of match, feedback to other users, among other things.

It is contemplated that text entry fields, radio buttons, drop down menus, other forms of browser input, and/or other known input formats may be used to facilitate the entry of profiles.

The user 210 may enter multiple profiles into the data center 246. The multiple profiles may be based on a variety of criteria, including interests, affiliations, associations, events, employment, dating, exchanging goods and services, business networking, connecting friends and acquaintances, genealogy trees, and other categories. In addition, 2 profiles may have similar content, but allow the user to match with different segments of users, for instance a university profile based on hometown and interests, and a conference profile which matches on similar criteria, but with a different segment of users.

In one example, to protect the privacy of the user 210, access to profile data is limited. Profiles are matched in the datacenter to create matched data that is downloaded to the user's device. This matched data can be encrypted on the device and only displayed when a matched user is encountered. In addition, in one embodiment, only the information that the two matched users share in common would be displayed on a user's device. For example, the user 210 may be interested in gardening, and may choose to share only his gardening profile (but not other profiles of his) with others who are also interested in gardening.

Step 104 of the method will now be further described. In one embodiment, the data center 246 may pre-processes all matches among user profiles by evaluating the user 210 based on all other users' or subset of users' information stored in the data center 246, and assigning a score to each relationship based on its relevance. For example, matches with a great number of commonalities will receive high scores, indicating great relevance. Generally, the profiles are compared, and a new record in a match ID database table is created for a match, resulting in a new file that will be synchronized to the device 204 during step 106. Storage capacity on a mobile device may determine how many match IDs are downloaded to it. If there is not enough room to download all match IDs, then the downloaded match IDs may be prioritized, based on relevance score, specific users, geographical areas, common friends, specific affiliations, associations, conference events, or tagged information, among other things.

When the profiles of user 210 are compared with those of a second user, relevance scores can be either identical or different for each of the users. The user 210 may be equally or more relevant to the second user than she is to him, depending on the nature of the relationship. For example, in a mentor/mentee relationship, the mentor is more valuable, and therefore more relevant to the mentee.

Based on user preferences, the data center 246 may also employ the option of blocking users from detecting each other. Two types of blocking (one-way blocking and two-way blocking) may be utilized. For example, one-way blocking allows the user 210 to remain invisible to a second user but retain the ability to identify the second user when they encounter each other. Two-way blocking will cause each of them to become invisible to the other.

Several IDs, which may include a client ID, field ID, and match ID may be adopted for the user 210 during step 104.

The client ID is a public identifier that may be broadcasted from the device 204, and is used to detect a match in proximity as described below during step 110. In one example, the client ID may be used to shield the true identity of the user 210 for privacy purposes. Alternatively, the client ID may simply be the user ID of the user 210.

The field ID is used within a match ID (below) to abstract specific data in a profile associated with the user 210, so that this data can be distributed inside a match ID, to other (matched) users, without disclosing the values of the data that was input. For example, if the datacenter matched user 212 with user 210, when user 210 detects user 212, the field ID displays the matched value from user 210's own profile. A field ID for “University” could be XML6463, and the value entered into that field by a user 210, is “Harvard.” Thus, when a match detection occurs based on the field ID “XML6463,” “Harvard” will be displayed on the device 204. Because matches can be based on differences, as much as similarities, data values triggered by identical field IDs can be different. In the above example, when the match detection occurs, even if user 210 has “Harvard” displayed for field ID “XML6463”, user 212 may have “Stanford”, or another value. Alternatively, the value of the field ID can equal the value entered into the profile.

The match ID represents data processing results, such as matched data, and is synchronized onto the device 204 during step 106. Among other functions, the data center 246 utilizes the profiles entered by the user 210 to compare profiles, calculate relevance scores, generate match IDs based on the results of each comparison. A match ID is the result of a comparison between two profiles, and may include the public client ID of the other user, relevance and trust scores, tagged information, creation/modification date, a secured hash value based on SHAL or other hash algorithms, and/or other information.

In one example, a match ID stored on user 210's mobile device, is in the format of 4209032-4-6054-XML6463-8044-909033-842393-1214 pm08052003-SHAq4309310912jd32js. Here, 4209032 is the client ID of another user; 4 is the relevance score (representing how relevant the user 4209032 is to the user 210); 6054 is the trust score (representing how trusted the user 4209032 is among users of the data center 246); XML6463 is the field ID; 8044-909033-842393 represents the displayed value when the match occurs under XML6463; 231108052003 is the creation date; and SHAq4309310912jd32js is the hash value for the user 4209032 that is generated by SHA1 or other hash algorithm.

The hashing process may be utilized to authenticate a matched user and to prevent the unauthorized alteration of the match ID. Hash values are generated in the data center 246 for the user 210 and the user 302. After the match IDs are generated, hash values are generated on them. Each user receives the other's hash value from the datacenter. When a match is detected (described below), a new hash value is calculated on 302's mobile device for matchID user 210 and sent to user 210 to be compared with the original hash value that 210 received from the datacenter for user 302, so that a determination may be made with respect to whether the match ID has been altered. It is contemplated that other security processes that are known in the art may be used to authenticate matched users and the unauthorized alteration of the match ID.

Step 106 of the method 100 will now be described. In one embodiment, the match IDs generated for the use 210 may be compressed into a file, and downloaded to the device 204. The file may include compressed extensible markup language (XML) text and binary streams that can be searched economically, and/or other formats. The file compression may be context independent, so that differential synchronizations may be implemented: once the device 204 is completely synchronized with the information reserved for the user 210 in the data center 246, subsequent changes may be downloaded to the device 204, so that the complete set of data is not required to be downloaded again. Additionally, the context-free nature of the file allows modification to an individual XML stream, so that local modifications to the file (such as feedback, new reminder notes, or other features) may be entered into the device 204 and uploaded pursuant to step 114 to the data center 246 during synchronization.

Many optional features for the user 210's file are contemplated by the present disclosure. In one example, to increase search speed, more probable matches may be indexed and placed at the top of the file, so that they are more readily available. In another example, probable matches may be sorted by geographic proximity to the user 210: if the user 210 lives in Atlanta, then matches with others who live in Georgia are more probable than those living in Australia. In a third example, probable matches may be sorted based on criteria such as whether other users are attending a conference with the user 210, whether other users communicate with the user 210 frequently, whether other users have certain relationship with the user 210 based on categories such as friendship, alumni status, zip code, industry, job function, and/or other categories. In a fourth example, the match IDs are indexed by relevancy, so that the user 210 is quickly notified of the most relevant matches. In a fifth example, profile masks such as professional and personal masks may be used to arrange the order of the file.

Step 108 of the method 100 will now be further described. Referring now to FIG. 3, in one embodiment, following the completion of step 106, the user 210 may launch a program residing on the adapter 208, so that beacon data such as his client ID (and possibly his availability level and other identification information, such as trust score, status, etc) is broadcasted within an approximately 300-foot range. It is also contemplated that the 300-foot range may be extended or reduced.

Many features may be employed by the adapter 208. In one example, the adapter 208 may enable the user 210 to dynamically adjust his availability on the device 204 based on context and/or environment. For example, at a bar, the user 210 may be interested in romantic matches this time, but may also be open to business networking at another time. In another example, the availability level may be a value between 0 to 10, which serves as a filter to notify the user 210 of match scores that are higher than his availability level. If the user 210 attends an important meeting, he may set his availability to 0, so that all matches are logged (however, he is not notified of the match during the meeting). After the meeting, he may turn his availability level to 7, so that he will be immediately notified of many more current matches.

In practice, if a match is found between the user 210 and the user 212, the adapter 208 may compare availability levels to determine if they are below the relevance scores. In one example, if the availability levels of the users 210 and 212 are 2 and 5, respectively, and the relevance scores are both 6, then neither user is notified of the encounter. However, if the users 210 and 212 modify their availability levels to 8 and therefore, larger than the relevance score 6, then a match is confirmed. Subsequently, when the users 210 and 212 are notified of the match, the match ID from each of the users 210 and 212 may trigger the relevance score of the match, the trust value (discussed below), and the primary commonalities (such as “Cornell University”) to be displayed on the devices 204 and 206.

In one example, when a match score is below the availability level of the user 210, it may be logged on the device 204 and reviewed by the user 210 at a later time. The log may include the date and time of the encounter, the match score, and the match ID. The log presents the user 210 with missed matches, and enables him to adjust his availability level to optimize for a given environment. For example, if a logged match score is 5, he may adjust his availability level from 4 to 6. At that time, if the matched device is still present, a connection may be established between the user 210 and the matched user.

Availability settings may also be associated with certain data sets or segments of users, such as those that are work related or recreational. or other categories. For example, the user 210 and the user 212 may share commonality in work and the user 210 and the user 302 may share commonality in university. However, if the user 210 has selected a “work mask,” then the adapter 208 may broadcast a “work” availability level in order to filter matches that are primarily work related. Broadcasting a “work” availability level would only notify user 210 of work related matches and would instruct the adapter of other users in proximity to only notify their users of a match if it is work related. As a result, the user 210 would be notified of a match with user 212, but not with user 302, which could just be logged. Thus, users may broadcast different masks to emphasize certain criteria, and change them dynamically to suit a particular environment. In another embodiment, adapter 208 may not need to broadcast a work availability level to filter out non-work related matches. The user could specify instructions as part of his/her profile that could be included in the match ID to instruct other users' adapters 208 to only notify their users of a match under certain circumstances such as times of day, days of week, certain dates, certain SSIDs, among other things. It is contemplated that the user 210 may also choose to be invisible to other users.

The adapter 208 may also learn which mask the user 210 prefers to broadcast, so that the user 210 does not have to manually adjust his profile mask or availability level. The adapter 208 may use a variety of criteria to predict the preference of profile mask and availability level. For example, when the user 210 utilizes a particular network, such as a company's intranet, then he may prefer work related matches. Also, the adapter 208 may use the current active application (such as PowerPoint or other professional applications) as well as recently active applications, to determine whether the user 210 is available for work related matches (as opposed to recreation related matches).

Step 110 of the method 100 will now be further described. The detection process may be used for notifying the user 210 of another client ID that is on the same or different network subnets, and/or within wireless proximity.

In one embodiment, WiFi technology may be utilized to implement step 110. Generally, WiFi may operate in infrastructure and ad hoc modes, each of which may be utilized herein. For example, the ad hoc mode allows WiFi NICs to connect directly without infrastructure, as long as they both share an identical identifier, such as a SSID (a unique 32-character ID for a wireless network). The identifier is attached to the header packets transferred over a WiFi connection, thereby differentiating among WLANs, as two NICs with an identical SSID reside on the same logical network.

In another embodiment, Bluetooth technology may be utilized to implement step 110. ClientIDs can be broadcast between Bluetooth devices on the same piconet to enable pairing and service discovery on the same network.

Pursuant to this step, the adapter 208 is able to detect nearby devices regardless of the network the devices are associated with. For example, if both the device 204 and the device 206 reside on the same network (Ethernet, WiFi ad hoc, WiFi infrastructure, Bluetooth, etc.), technologies known in the art, such as transmission control protocol/internet protocol (TCP/IP) service discovery may be utilized to detect relevant client IDs. If the device 204 and a device 304 reside on different networks, at least four options are available as set forth below.

The first option of MAC address detection will now be described. As described previously, the user 302 may be associated with one or more client IDs, which identify her publicly. In one example, her client ID may be the unique MAC address of her WiFi NIC. Thus, detection of the user 302 may be accomplished as long as the devices 204 and 304 are within a certain range of each other. If the user 302 holds multiple WiFi devices, then several MAC addresses may be used to identify her.

In practice, by utilizing standard 802.11 frames, the device 204 (operated by the user 210) may query access points in proximity to obtain a list of MAC addresses. The adapter 208 may obtain the MAC address of any ad hoc nodes in the vicinity, and may utilize network “sniffing” technology at the 802.3 layer or MAC layer. The adapter 208 may distribute periodic requests at intervals, requesting the MAC addresses and access points in its vicinity.

Since the availability level of the user 302 is broadcasted along with her client ID (by WiFi SSID or other means), the adapter 208 residing on the device 204 may determine relevance by examining the user 302's client ID and the availability levels of both users 210 and 302. If a match is found and availability status is satisfactory, then the users 210 and 302 are notified, and a network layer communication (TCP/IP or other protocol) may be established.

The second option of SSID detection will now be described. In one embodiment, the adapter 208 may generate a unique identifier, such as a SSID or other ID, for the user 302 based on her client ID and availability level. Accordingly, the device 204 may detect the user 302 by her SSID.

Once a desirable SSID is detected, either of the devices 204 and 304 may join the other's network, so that the two devices 204 and 304 may establish a connection on the same network, according to methods known in the art.

The third option of time-slicing to join and bounce between several networks will now be described. In one embodiment, the adapter 208 may use NDIS and a WLAN driver to automatically associate the device 204 with both ad hoc and infrastructure networks simultaneously, staying within the timeout threshold for a given network. The adapter 208 may use NDIS calls to associate back and forth between the ad hoc mode (for detecting other users in proximity) and the infrastructure mode (for accessing Internet resources), creating virtualized simultaneous networks. The “time slicing” bounces between being associated with an access point for a given number of milliseconds, and being in an ad hoc mode for a given number of milliseconds. Since the detection process requires limited bandwidth, the adapter 208 can automatically “weigh” the amount of time it spends on each mode, so that resources may be economically distributed.

The time-slicing technology employed by the adaptor 208 may also allow the device 204 to bounce between two or more infrastructure networks. If the device 204 is connected to one network but uses resources of another network, it may appear to be connected to multiple networks simultaneously.

The fourth option is to use separate network interfaces for each network, so that the device can be simultaneously connected to multiple networks (one per interface), without having to bounce between them. For example, one WiFi interface could join an infrastructure network and detect matches on that subnet, while another WiFi network interface could be configured in ad-hoc mode, “beaconing” its client ID, and a third Bluetooth interface could be available to pair to Bluetooth users in proximity, according to methods known in the art.

If the detection process occurred on separate networks, the users 210 and 302 may join the same SSID hardware-link layer, and negotiate a network connection at the network protocol layer. For example, a ZeroConf (open standard, also referred to as Rendezvous or OpenTalk) TCP/IP-layer negotiation may be employed to communicate and exchange further information/services at the protocol layer.

A trust system may be optionally utilized during step 110. From the perspective of the user 210, when a match with the user 212 is detected, a trust value for the user 212 may be displayed on the device 204. Accordingly, the user 210 is able to assess the level of integrity of the user 212 for determining whether to engage the user 212. A trust level may be calculated based on one or more of the following or other criteria:
1) Date the user 212 joined the data Center 246;
2) Number of successful transactions out of number of total transactions performed by the user 212;
3) Total number of transactions performed by the user 212;
4) Number of introductions by friends;
5) Number of successful introductions by friends;
6) Number of other users that list the user 212 on their contact lists;
7) Number of trusted affiliations that the user 212 belongs to; and/or
8) Date on which part of her profile was created. Accordingly, matches based on criteria that have been stored for a long time may be relatively more trustworthy.

It is noted that besides WiFi, other wireless platforms, including but not limited to Bluetooth, Zigbee, WiMax, RFID and UWB, are also contemplated by the present disclosure. Therefore, the step 110 may be modified to suit other wireless platforms. In addition, even though a 300-foot range is cited as an example herein, a smaller or larger range is also contemplated for filtering the number of matches in proximity by adopting known technologies, such as detecting signal strength or multi-hop network. Signal strength could be used to narrow the range of other users in proximity, thereby filtering out matches that are farther away, and vice versa.

Step 112 of the method 100 will now be further described. In one embodiment, the adapter 208 may utilize extensible messaging and presence protocol (XMPP) to relay XML-based messages and present information between matched users 210 and 302 in real time.

If both users 210 and 302 are interested in the match, they may use the XMPP-enabled adapter 208 to message anonymously within their ad hoc wireless network communicate and to determine a meeting place. The messaging platform may function similarly to a decentralized instant messenger system. In practice, following the establishment of the ad hoc network, the adapter 208 may use the TCP/IP protocol to create a messaging connection between the two devices 204 and 304. It is noted that other messaging means, such as any of the short-range radio technologies, WiFi, Bluetooth, short messaging services (SMS), voice over Internet protocol (IP), push-to-talk, cell phone, voicemail, video conferencing, or other suitable means, are also contemplated by the present disclosure.

Many variations of the above example are contemplated by the present disclosure. In one example, a tagged connection feature may be included herein. The tag information may be attached to one or more devices. A user may tag information to himself, so that he will be reminded of a particular user during a future match. A user may distribute a message to introduce himself to a match that he may encounter in the future. A user may also distribute an introduction message to one or more parties he may encounter in the future. The tagged connection information may be included in the match ID and synchronized to the user's device.

A user may tag “notes” to himself to be displayed when a particular match or person is encountered. A user may tag information to be displayed on another user's device when a specific match or person is encountered. A user may also tag information to a networking goal to meet a specific person, so that when he “meets” a targeted individual, the tagged information will be displayed on that individual's device.

A user may also link two of his friends or acquaintances by “introducing” them with a note. The “introduction” message may be tagged to both acquaintances' devices, so that the message will be displayed on their devices when they encounter each other. The matches are pre-processed by the common friend at the data center, and the introduction message may describe the purpose of matching them, and may include any other suitable information.

In a second example, users of the system may communicate at a later time based on a previous match. When a match occurs, it is logged. However, many users may not take actions at the time of the encounter. Later, when a user synchronizes his data with the data center, the client ID of the encounter is uploaded pursuant to step 114 (along with the match time and other usage information), and he may identify a list of his most recent matches online. He may have a window of opportunity (such as 48 hours or another duration) to communicate anonymously with a matched user, using an online messenger tool, email anonymizer, SMS, email, and/or other methods. Since the location and time of the match is known only to the matched users, the information may be used to authenticate the participating parties.

In a third example, the system may enable third parties to form closed or trusted affiliations for personal area matching, allowing their members to be matched without requiring user input. For example, the system may pre-process a pool of client IDs, matching them solely based on the affiliation, and then transfer those client IDs to the third party to be distributed to its members or allow those members to download them directly from the datacenter. As a result, a member is able to “see” all of the other members of the affiliation, as they have been pre-processed and pre-authenticated. In this example, members do not need to enter information about themselves into the first set of data, in order to detect other members from that affiliation.

In a fourth example, the system may include the ability for a third party to broadcast a client ID for a particular affiliation.

In a fifth example, a combination of a peer to peer and centralized communication systems may be employed. Instead of pre-synchronizing all matches to the mobile device, match IDs detected in proximity may be downloaded from a centralized system to the device. As a result, storage space on the device may be saved. The system may utilize proximity-based matching (discussed above) by leveraging a bluetooth module on mobile devices to detect a match, and then employ a cell connection such as general packet radio service (GPRS), CDMA, or SMS to download from the datacenter, the individual match IDs that are within proximity.

Although only a few exemplary embodiments of this disclosure have been described in details above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. Accordingly, all such modifications are intended to be included within the scope of this disclosure.

1. A method of providing communication services to a plurality of mobile device users, comprising:
entering a first set of data into a data center;
processing the first set of data in the data center to generate a second set of data;
downloading the second set of data to a first mobile device to form a third set of data to be stored on the first mobile device; and
detecting, by the first mobile device, a second mobile device according to the third set of data wherein the second mobile device is located within a range of the first mobile device, wherein communication between the first mobile device and the data center after downloading the second set of data is not required for detecting the second mobile device.

2. The method of claim 1 wherein the first set of data is entered by a user.

3. The method of claim 1 wherein the first set of data is entered by a third party.

4. The method of claim 1 wherein the first set of data is automatically entered based on usage information from a user's usage of services.

5. The method of claim 1 wherein the first set of data comprises one or more personal profiles.

6. The method of claim 1 wherein the processing comprises comparing the first set of data with profiles of other users.

7. The method of claim 1 wherein the third set of data comprises matched data.

8. The method of claim 7 wherein the matched data are established based on shared commonality between a user and other users.

9. The method of claim 7 wherein the matched data are established based on a shared third party between a user and the other users.

10. The method of claim 7 wherein a third party determines the basis of the matched data between a user and other users.

11. The method of claim 7 wherein the matched data are prioritized, wherein a user is notified when the most relevant matches are in proximity.

12. The method of claim 11 wherein the user can filter relevant matches and limit the ability of other matched users to be notified of his presence based on his filter settings.

13. The method of claim 1 wherein the second set of data is processed before the detecting.

14. The method of claim 1 wherein the third set of data comprises one or more client IDs of other users that do not reveal the true identities of the other users.

15. The method of claim 1 wherein the third set of data comprises one or more client IDs of other users that do reveal the true identities of a subset of the other users.

16. The method of claim 1 wherein the first and second mobile devices are WiFi devices.

17. The method of claim 1 wherein the first and second mobile devices are Bluetooth devices.

18. The method of claim 1 wherein the first and second mobile devices reside on an identical network during the detecting.

19. The method of claim 1 wherein a WiFi ad hoc mode is used during the detecting.

20. The method of claim 1 wherein the first and second mobile devices reside on different networks during the detecting.

21. The method of claim 1 wherein the media control access (MAC) address of the second mobile device is used for the detecting.

22. The method of claim 1 wherein the detecting by the first mobile device occurs on multiple networks simultaneously, using multiple interfaces.

23. The method of claim 1 wherein an identifier of the second mobile device is used for the detecting, wherein the identifier is based on identification information and availability level of the second mobile device's user.

24. The method of claim 1 wherein an identifier of the second mobile device is used for the detecting, wherein the identifier is based on identification information and other beacon data of the second mobile device's user.

25. The method of claim 1 wherein a service set identifier (SSID) of the second mobile device is used for the detecting, wherein the SSID is based on identification information and availability level of the second mobile device's user.

26. The method of claim 1 wherein a service set identifier (SSID) of the second mobile device is used for the detecting, wherein the SSID is based on identification information and other beacon data of the second mobile device's user.

27. The method of claim 1 wherein a service set identifier (SSID) of the second mobile device is used for the detecting, wherein the SSID is based on identification information of an affiliation.

28. The method of claim 1 wherein time-slicing to join and bounce between networks by either the first mobile device or the second mobile device is utilized for the detecting.

29. The method of claim 1 wherein the second set of data is identical to the third set of data.

30. The method of claim 1 wherein a fourth set of data is created after detecting a second mobile device, wherein the creation is based on the encounter with the second mobile device's user.

31. The method of claim 1 wherein a fourth set of data is added to the first set of data.

32. A system for identifying possible matches and providing communication between users of mobile devices, comprising:
a data center for receiving and processing a first set of data entered to generate a second set of data;
a first mobile device for downloading the second set of data from the data center to form a third set of data stored on the first mobile device; and
a second mobile device moving within a range of the first mobile device, wherein without any real-time assistance from the data center, the first mobile device is operable to detect the second mobile device based on meeting one or more predetermined criteria according to the third set of data.

33. The system of claim 32 wherein the first set of data is entered by a user.

34. The system of claim 32 wherein the first set of data is entered by a third party.

35. The system of claim 32 wherein the first set of data is automatically entered based on usage information from a user's usage of services of the system.

36. The system of claim 32 wherein the first and second mobile devices are WiFi devices.

37. The system of claim 32 wherein the first and second mobile devices are Bluetooth devices.

38. The system of claim 32 wherein the first and second mobile devices reside on different networks during the detection.

39. The method of claim 32 wherein the detection occurs on multiple networks simultaneously using multiple interfaces.

40. The system of claim 32 wherein the media control access (MAC) address of the second mobile device is used for the detection.

41. The system of claim 32 wherein an identifier of the second mobile device is used for the detection, wherein the identifier is based on identification information and availability level of the second mobile device's user.

42. The system of claim 32 wherein an identifier of the second mobile device is used for the detection, wherein the identifier is based on identification information and other beacon data of the second mobile device's user.

43. The system of claim 32 wherein time-slicing to join and bounce between networks by the first mobile device is utilized during the detection.

44. The system of claim 32 wherein the quality of a device's signal strength based on its approximate distance from a user is used to adjust the range of detection of other users in proximity.

45. A method of identifying possible matches and providing communication between users of mobile devices, comprising:
entering profile information into a data center wherein the profile information comprises one or more profiles;
processing the profile information in the data center to generate matched data wherein the processing comprises comparing the profile information with profiles of other users;
downloading the matched data to a first WiFi device; and
detecting by the first WiFi device, a second WiFi device having identification information included in the matched data stored in the first WiFi device, wherein the detection is accomplished without any real-time assistance from the data center.

46. The method of claim 45 wherein the profile information is entered by a user.

47. The method of claim 45 wherein the profile information is entered by a third party.

48. The method of claim 45 wherein the profile information is automatically entered based on usage information from a user's usage of services.

49. The method of claim 45 wherein the media control access (MAC) address of the second WiFi device is used for the detecting.

50. The method of claim 45 wherein the detecting by the first mobile device occurs on multiple networks simultaneously, using multiple interfaces.

51. The method of claim 45 wherein a unique identifier of the second WiFi device is used for the detecting, wherein the indentifier is based on identification information and availability level of the second WiFi device's user.

52. The method of claim 45 wherein a unique identifier of the second WiFi device is used for the detecting, wherein the identifier is based on identification information and other beacon data of the second WiFi device's user.

53. The method of claim 45 wherein time-slicing to join and bounce between networks by the first WiFi device is utilized during the detecting.

54. The method of claim 45 wherein the quality of the first WiFi device's signal strength based on its approximate distance from a user is used to adjust the range of detection of other users in proximity.

55. A method of identifying possible matches and providing communication between users of mobile devices, comprising:
entering profile information into a data center wherein the profile information comprises one or more profiles;
processing the profile information in the data center to generate matched data wherein the processing comprises comparing the profile information with profiles of other users;
downloading the matched data to a first Bluetooth device; and
detecting by the first Bluetooth device, a second Bluetooth device having identification information included in the matched data stored in the first Bluetooth device, wherein the detection is accomplished without any real-time assistance from the data center.
